(19) United States
(12) Patent Application Publication
(10) Pub. No.: US 2005/0161028 A1
(43) Pub. Date: Jul. 28, 2005

(54) Gaseous fuel mixer and method of operation

(76) Inventor: Leendert Wolters, EK Rhoon (NL)

Correspondence Address: FISH & RICHARDSON P.C., 1717 MAIN STREET, SUITE 500, DALLAS, TX, 75201, US

(21) Appl. No.: 10/763,371

(22) Filed: Jan. 23, 2004

(51) Int. Cl. F02M 21/04; C10J 1/00

(52) U.S. Cl. 123/527; 123/568.17; 137/896

(57) ABSTRACT

A gaseous fuel mixer includes a venturi defining a flow area that decreases from an inlet opening to a throat. The throat coincides with a minimum flow area of the venturi. The gaseous fuel mixer further includes a fuel delivery body in the flow area extending transverse to a longitudinal axis of the venturi and positioned between the throat and the inlet opening. The fuel delivery body is adapted to introduce gaseous fuel into the venturi at a trailing edge thereof opposite the inlet opening. The trailing edge of the fuel delivery body substantially coincides with the throat.

### TECHNICAL FIELD

This invention relates to gaseous fueled engines, and more particularly to a gaseous mixer for use with a gaseous fueled engine.

### BACKGROUND

A gaseous mixer resides in an intake of an engine and functions to meter gaseous fuel flow in accordance with airflow and engine requirements to obtain a desired air to fuel ratio. Intake air passes through a venturi of the gaseous fuel mixer. The venturi reduces the flow area of the intake air, thereby speeding up the airflow and causing a lowered dynamic pressure within the venturi. The lowered pressure draws fuel from a plurality of fuel delivery outlets about the venturi and on a fuel delivery body extending into the venturi's interior. Because the amount of fuel introduced by the fuel delivery outlets is a function of air speed, it is difficult to produce fuel delivery outlets that introduce a proper amount of fuel at high air speeds, for example those achieved while the engine is at operating speed, and that also introduce a proper amount of fuel at low air speeds, for example those achieved while the engine is cranking. In an attempt to maximize air speed across the fuel delivery outlets, the outlets are positioned in the throat of the venturi. The fuel delivery body having fuel delivery outlets thereon is also positioned in the throat of the venturi. In this position, the fuel delivery body is an obstruction to airflow, further reducing the flow area at the throat and the flow through the gaseous fuel mixer.

There is a need for a gaseous fuel mixer that has improved fuel delivery characteristics at low air speeds, as well as, presents a reduced flow obstruction to the flow of intake air.

### SUMMARY

The invention encompasses a gaseous mixer and a method of mixing gaseous flows to achieve improved mixing at low intake flow speeds as well as present a reduced flow obstruction to the intake flow.

One illustrative embodiment is drawn to a gaseous mixer that includes a venturi defining a flow area that decreases from an inlet opening to a throat. The throat coincides with a minimum flow area of the venturi. The gaseous mixer further includes a gas delivery body in the flow area extending transverse to a longitudinal axis of the venturi and positioned between the throat and the inlet opening. The gas delivery body is adapted to introduce gaseous flow into the venturi at a trailing edge thereof opposite the inlet opening, and the trailing edge of the gas delivery body substantially coincides with the throat.

Another illustrative embodiment is drawn to method of mixing gaseous flow where a flow of air is received through a venturi. The venturi has a smallest flow area through the venturi at a throat. Gaseous flow is received through an interior of a gas flow body upstream of the throat. The gaseous flow from the gas flow body is received into the flow of air substantially at the throat.

The details of one or more illustrative embodiments of the invention are set forth in the accompanying drawings and the description below. Other features, objects, and advantages of the invention will be apparent from the description and drawings, and from the claims.

### DESCRIPTION OF DRAWINGS

FIG. 1 is a perspective view of a gaseous mixer constructed in accordance with the invention;

FIG. 2 is an outlet end view of a venturi of a gaseous mixer constructed in accordance with the invention;

FIG. 3 is a side cross sectional view of the venturi of FIG. 2 along line 3-3;

FIG. 4 is a cross sectional view of a gas delivery tube of the venturi of FIG. 2 along line 4-4; and

FIG. 5 is a schematic of a gaseous mixer constructed in accordance with the invention incorporated into an engine system.

### DETAILED DESCRIPTION

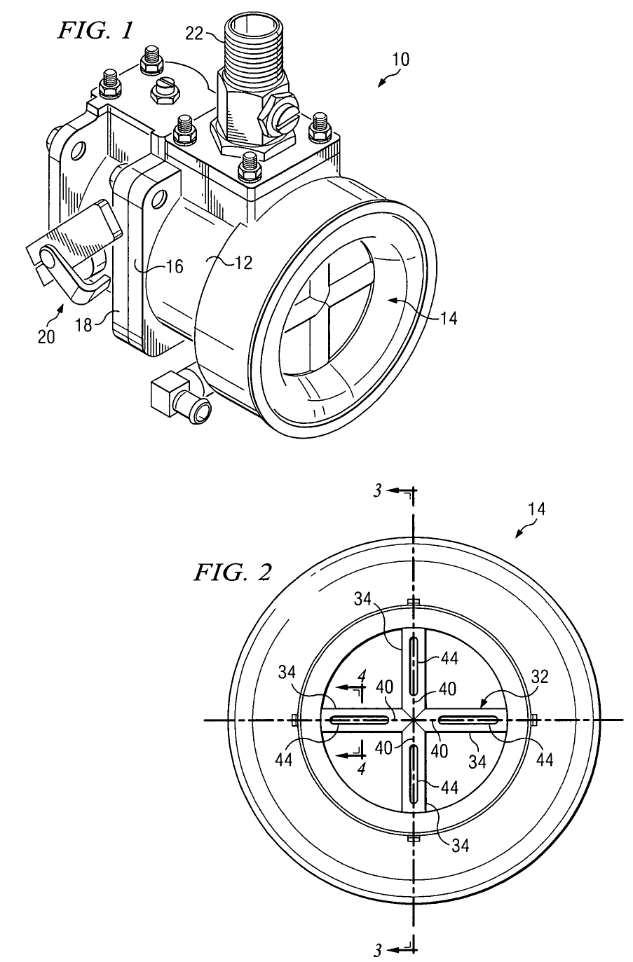

Referring first to FIG. 1, an illustrative gaseous mixer 10 constructed in accordance with the invention is depicted in perspective view. The gaseous mixer 10 has an external housing 12 that internally receives a venturi 14. The external housing 12 may be provided with one or more mounting flanges 16 adapted to enable attachment of the gaseous mixer 10 to other components. In the illustrative gaseous mixer 10 of FIG. 1, the mounting flange 16 abutting a corresponding mounting flange 18 of a throttle valve 20. However, the gaseous mixer 10 can also be used apart from a system having a throttle valve 20. An inlet 22 into the gaseous mixer 10 is provided into the housing 12 in communication with the venturi 14.

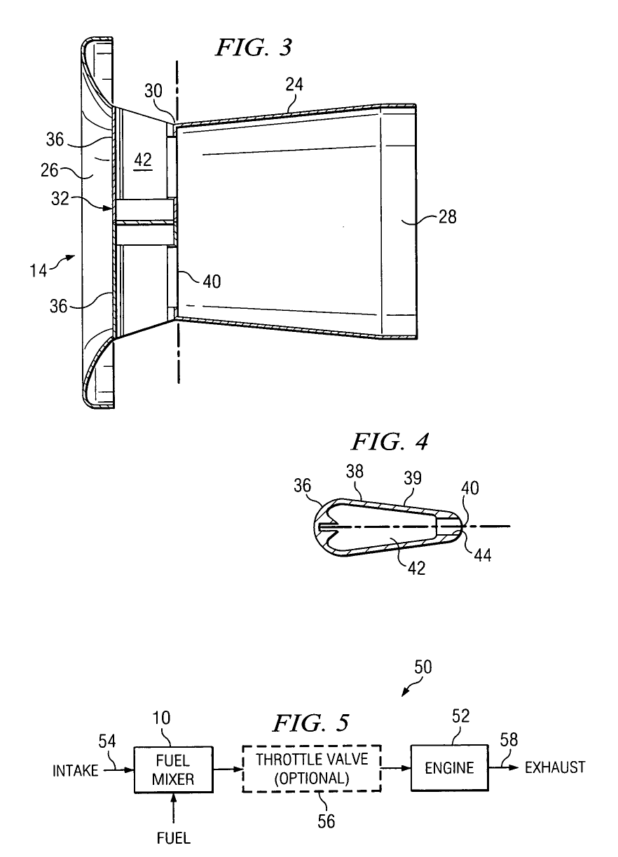

Referring to FIGS. 2 and 3, the venturi 14 is defined by an elongate, substantially tubular body 24 having an inlet end 26 and an outlet end 28. The inlet end 26 defines a bell-shape curvature, curving inward into an interior of the tubular body 24. A flow area within the tubular body 24 decreases from the inlet end 26 to a throat 30, and increases from the throat 30 to the outlet end 28. In the case of the illustrative gaseous mixer 10, the venturi 14 has a circular cross section; therefore, an inner diameter of the venturi 14 decreases from the inlet end 26 to the throat 30, and increases from the throat 30 to the outlet end 28. The throat 30 corresponds to the smallest flow area or inner diameter of the tubular body 24.

A gas delivery body 32 is positioned between the inlet end 26 and the throat 30 and is provided in communication with the inlet 22 of the housing 12. The gas delivery body 32 is defined by one or more gas delivery tubes 34 extending substantially transverse to a longitudinal axis of the venturi 14 in the interior thereof. The illustrative embodiment of FIG. 2 depicts the gas delivery body 32 as being four gas delivery tubes 34 configured in a cross arrangement to meet at the center of the venturi 14; however, it is within the scope of the invention that the gas delivery body 32 be alternately configured and that a fewer or a greater number of gas delivery tubes 34 be provided. For example, the gas delivery body 32 may be configured as a single gas delivery tube 34, two gas delivery tubes 34 in a T-shape, three gas delivery tubes 34 in a Y-shape, or otherwise.

As seen in FIG. 4, one or more of the gas delivery tubes 34 may have a substantially airfoil cross section defined by a rounded, inlet facing leading edge 36 transitioning to a broad central body 38 and tapering to an outlet facing trailing edge 40. Although the gas delivery tube 34 of FIG. 4 is depicted as being symmetrical about its central axis, the gas delivery tube 34 may alternately be asymmetrical about its central axis. An axial passage 42 in the interior of the gas delivery tube 34 communicates gas from the inlet 22 of the housing 12 to one or more gas delivery outlets 44 about the trailing edge 40. The gas delivery outlets 44 have an opening sized to meter the flow of gaseous fuel, or other gaseous flow, to a desired rate as a function of the pressure difference between the gaseous pressure in the gas delivery body 32 and the pressure in the venturi 14. The pressure in the venturi 14 is a function of, among other things, air speed. Although depicted in the illustrative gaseous mixer 10 as being slot shaped, the openings of the gas delivery outlets 44 may be other configurations, including a plurality of apertures about the trailing edge 40.

The gas delivery outlets 44 may be positioned substantially directly on the rearward facing trailing edge 40. Alternatively or in combination with gas delivery outlets 44 directly on the rearward facing trailing edge 40, gas delivery outlets 44 may be positioned on lateral facing surfaces adjacent the rearward facing trailing edge 40. As airflow passes through the venturi 14 and over the gas delivery tubes 34, a relatively low dynamic pressure at the trailing edge 40 of the gas delivery tubes 34 develops and draws gas from the inlet 22, through the axial passage 42 and out the gas delivery outlets 44. While it is within the scope of the invention to provide additional gas delivery outlets apart from those opening about the trailing edge 40 of the gas delivery tubes 34, additional openings on the leading edge of the gas delivery tubes 34 may pressurize the axial passage 42 and reduce or cease the flow of gaseous flow into the venturi 14.

The gas delivery outlets 44 can be oriented substantially parallel to the longitudinal axis of the venturi 14 in the direction of airflow to introduce gaseous flow substantially parallel to the flow at the throat 30. It is within the scope of the invention, however, that the gas delivery outlets 44 be oriented at an acute or other angle to the longitudinal axis of the venturi 14 or substantially parallel to the direction of flow at various points along the gas delivery body 32. By positioning the gas delivery outlets 44 oriented substantially parallel to the longitudinal axis of the venturi 14 in the direction of airflow, head loss in the flow of gaseous flow is reduced relative to gas delivery outlets oriented substantially perpendicular to the longitudinal axis of the venturi 14.

The gas delivery body 32 is positioned in the venturi 14 with the openings of the gas delivery outlets 44 substantially coinciding with the throat 30 of the venturi 14. In this position, the openings are in the area of highest air speed and correspondingly lowest pressure within the venturi 14. The affect of the gas delivery body 32 on flow area through the venturi 14 can be reduced by positioning the gas delivery body 32 such that no portion or no substantial portion of the gas delivery body 32 extends beyond the throat 30. In the illustrative gaseous mixer 10, the trailing edge 40 is positioned to substantially coincide with the throat 30 of the venturi 14.

Use of a gas delivery body that crosses the flow path through the venturi (such as gas delivery body 32 in venturi 14) promotes homogeneous mixing of the inlet gas and air, because the gas delivery outlets can be more uniformly distributed in the flow. For example, in a venturi without a gas delivery body, the gas delivery outlets are distributed about the inner circumference of the venturi and introduce gas at the perimeter of the flow. The perimeter flow tends to receive more gas because of its proximity to the gas delivery outlets, while the flow through the center of the venturi tends to receive less gas because of its distance from the gas delivery outlets. In a venturi having a gas delivery body that crosses the flow path, the gas delivery outlets, and thus the gas, can be distributed more evenly through the flow.

Referring to FIG. 5, a gaseous mixer 10 is schematically depicted in the context of a engine system 50. The engine system 50 includes an engine 52 having a fuel mixer 10 in the intake path 54 and an exhaust 58. A throttle valve 56 is optionally provided in an intake path 54 before or after the fuel mixer 10. In operation, the gaseous mixer 10 meters flow of fuel to the internal combustion engine 52 in accordance with airspeed and engine requirements.

Beyond mixing gaseous fuel and air in an engine system, such as in FIG. 5, the gaseous mixer 10 can be used in a variety of applications. For example, the gaseous mixer 10 can be used in mixing re-circulated exhaust gas with the intake flow of an engine by feeding exhaust gas, rather than fuel, into the fuel mixer inlet. In another example, the gaseous mixer 10 can be used in mixing gases in the context of chemical production processes.

A number of embodiments of the invention have been described. Nevertheless, it will be understood that various modifications may be made without departing from the spirit and scope of the invention. Accordingly, other embodiments are within the scope of the following claims.

1. A gas mixer for use in an engine system, comprising:
a venturi defining a flow area that decreases from an inlet opening to a throat, the throat coinciding with a minimum flow area of the venturi; and
a gas delivery body in the flow area extending transverse to a longitudinal axis of the venturi and positioned between the throat and the inlet opening, the gas delivery body adapted to introduce gaseous flow into the venturi at a trailing edge thereof opposite the inlet opening, the trailing edge of the gas delivery body substantially coinciding with the throat.

2. The gaseous mixer of claim 1 further comprising at least one gas delivery outlet on the trailing edge that substantially coincides with the throat.

3. The gaseous mixer of claim 1 wherein the venturi extends along a longitudinal axis and the at least one gas delivery outlet is oriented to direct flow out of the gas delivery outlet substantially parallel to the longitudinal axis.

4. The gaseous mixer of claim 1 wherein the at least one gas delivery outlet is directed downstream.

5. The gaseous mixer of claim 1 wherein the gas delivery body has a continuous, unapertured leading edge opposite the trailing edge.

6. The gaseous mixer of claim 1 wherein the at least one gas delivery outlet is adapted to meter flow of gaseous fuel in relation to a flow of fluid through the venturi.

7. The gaseous mixer of claim 1 wherein a cross section of the gas delivery outlet is substantially airfoil shaped.

8. The gaseous mixer of claim 1 wherein the gas delivery body has a first and second members extending transverse to the longitudinal axis of the venturi, the first member angularly displaced from the second member.

9. The gaseous mixer of claim 1 wherein the gaseous flow is at least one of a fuel and exhaust.

10. An internal combustion engine system, comprising:
an engine; and
a venturi in an inlet of the engine, the venturi defining a flow area that decreases to a smallest flow area at a throat of the venturi, the throat defining a boundary between an upstream and downstream portion of the venturi; and
a gas delivery body in the venturi, the gas delivery body having a trailing edge with at least one gas delivery outlet therein adapted to introduce gaseous flow into the venturi, the trailing edge being positioned substantially outside of the downstream portion.

11. The internal combustion engine system of claim 10 wherein the venturi extends along a central axis and the at least one gas delivery outlet is oriented to direct flow out of the gas delivery outlet substantially parallel to the central axis.

12. The internal combustion engine system of claim 10 wherein the gas delivery body has a leading edge opposite the trailing edge that is free of apertures.

13. The internal combustion engine system of claim 10 wherein the at least one gas delivery outlet is adapted to meter flow of gaseous flow in relation to a flow of fluid through the venturi.

14. The internal combustion engine system of claim 10 wherein a cross section of the gas delivery body is substantially teardrop shaped.

15. The internal combustion engine system of claim 10 wherein the gas delivery body is configured in a cross pattern.

16. The internal combustion engine system of claim 10 wherein the gaseous flow is at least one of a fuel and exhaust.

17. A method of mixing gaseous fuel and air, comprising:
receiving a flow of air through a venturi, the venturi having a smallest flow area through the venturi at a throat;
receiving gaseous fuel through an interior of a fuel flow body upstream of the throat; and
receiving the gaseous fuel from the fuel flow body into the flow of air substantially at the throat.

18. The method of claim 17 wherein receiving the gaseous fuel from the fuel flow body into the airflow comprises receiving the gaseous fuel flowing out of the fuel flow body substantially parallel to the airflow.

19. The method of claim 17 wherein introducing gaseous fuel into the airflow comprises metering the amount of gaseous fuel in accordance with the airflow.
